(19) United States
(12) Patent Application Publication
(10) Pub. No.: US 2010/0189606 A1
(43) Pub. Date: Jul. 29, 2010

(54) Elemental Separation Process

(76) Inventor: Ryan Thomas Burleson, Bountiful, UT (US)

Correspondence Address: David L. Reoch, 11683 LAMPTON VIEW DRIVE, SOUTH JORDAN, UT, 84095, US

(21) Appl. No.: 12/359,102

(22) Filed: Jan. 23, 2009

(51) Int. Cl. B01J 19/08; B01D 19/00; B01J 19/00

(52) U.S. Cl. 422/112; 96/204; 422/129; 422/186.05; 422/198; 422/187

(57) ABSTRACT

The purpose of this system is to separate components of a molecule from the larger molecule or separate a molecule into smaller pieces. This system uses the shearing and/or breaking of molecular bonds using pressure waves, sudden pressure differentials, rotary movements, high velocity collisions to separate the molecule, or any combination of these methods. The system uses high voltage through no voltage to facilitate the separated or broken particles to remain in a separated state. For simplification purposes in the patent the drawings will show the separation of hydrogen from water molecules rather than to refer to all combinations; however, this patent refers in general to the separation of molecules/atoms of any size, shape, or configuration into a baser unit, separation of molecular components, or for distillation purposes. The process combinations described below can be used in any industry and for any reason without limitation. The devices mentioned in this application can be made of any material which supports the strains, stresses and pressures under which they are exerted with the understanding that all materials are subject to possible wear and deformations. Materials used for the process may be homogeneous; however, in most applications a variety of materials and combinations of materials will be used for components. The materials may undergo material tempering or they may not. For this process all levels of tempering and material strengthening are assumed included herein.

The following may or may not be used in the device in whole, in part, portions not at all, or replicated as many times as necessary to produce the device that creates the desired output. The device is comprised of a pressurization device, an exhaust system, a reservoir system and a pressure increasing system. In FIG. 1 it is shown a basic diagram of the apparatus. Any of the parts shown in FIG. 1 can be included with the system but do not necessarily need to be included in the system. The elements listed can be in any configuration, position, or any order of placement within or without the system. In the FIG. 1 complete system diagram there will be a heat exchanger and or agitation device (A), a high voltage elemental stimulator and/or wiper (B), a return line of expelled working fluid (C), higher weight gas/fluid exhaust (D), lower weight gas/fluid exhaust (E), inlet pressure pipe from pump (F), a pressure generation device (G), a fluid reservoir (H), an incidental gas exhaust (I), gas/fluid separation unit(s) after unit (J), gas/fluid separation unit(s) after unit (K), post j/k lighter gas/fluid exhaust (L), post j/k heavier gas/fluid exhaust (M), thickness of the walls of the high pressure area (N), elemental separation surface (ESD) (0), super collision device (P), high voltage elemental stimulator (Q), pressure sensor (R), thickness of the low pressure/vacuum area (S), high pressure area (T), low pressure area (U), and an elemental separation device support structure (V). Distinct states of matter exist within the overall device. For clarification purposes the states of the working fluid or solid being decompiled into components will be referred to as fluid one, which is in the reservoir and/or in the HPZ. Fluid two is the state or combination of fluids after the change effectuated by the work performed by the pressure differential.

The following may or may not be used in the device. The pressure device portion of the ESD is shown in FIG. 2. The pressure device portion of the invention is pressured in one or a combination of the following ways: movable pressure zones via an external source of pressure such that the pressure devices, whether they be cylinders or other are outside of the pressure zone (A) or inside the pressure zone or chamber (B). There may also be no movable pressure zones, where the pressure is exerted directly on the fluid located within the high pressure chamber via a pressure generation device (C). In any of the cases of a fully movable, partially movable, or non movable pressure zone there will also exist a filling valve containing or not a check valve or pressure device to allow more of the state one to enter the high pressure zone (HPZ) (see FIG. 1T). The Pressure device may be constructed of any material or combination of materials that is strong enough to withstand the rigors of the high pressure environment under which it will be subjected. The pressure device can be constructed of single or multiple pressurization units and be automatic, manual, electrical, hydraulic, mechanical or any combination in nature or operation. A portion or the entire molecule may undergo the process(s) described above with the possibility of a portion of the molecule being left in the HPZ.

The following may or may not be used in the device in whole or in part. The HPZ may also contain or not a heat exchanger and or agitation device; henceforth called the heat exchanger. This heat exchanger will be used to regulate the temperature of the working fluid. The heat exchanger may be introduced in the inside of the chamber, located inside the walls of the unit, or surround the HPZ. The heat exchanger will be constructed to bring fluids through a system of plumbing, use electrical heat exchange, use photo stimulation or any combination of heat exchange.

The following may or may not be used in the device in whole or in part. Connected to and or surrounding the HPZ via the Elemental Separation Plane (ESP) is the Gas Collection Area (GCA). The GCA may surround entirely or in part the HPZ to facilitate in desired volumes of purification/decompilation of fluid one. The GCA is at a lower pressure than the HPZ by any pressure(s) including an absolute vacuum, as the work is effectuated due to the change in pressure. Connected to the GCA is a suction line (FIG. 1E) to remove the lighter particles accumulated within the GCA. There is also a suction line connected to the GCA for heavier particles (FIG. 1B). The placement of these two lines is entirely dependant on the orientation of the HPZ and the GCA. In normal operations the lighter suction line orientation will be different than the orientation of the heavier particle suction line. Connected to each suction line may be a flashback arrestor which prevents ignited gas or vapors from damaging the GCA. The ESP may be small and in one location of the HPZ; however, the ESP may surround the entire HPZ.

The following may or may not be used in the device in whole or in part. Immediately inside the HPZ and in close proximity and/or in contact with the elemental separation plate (ESP) will be a particle wiper (FIG. 1D). The purpose of the wiper is to dislodge any particles and/or molecules that are clogging the ESP. This Wiper is used to improve flow and align particles properly inside of the device. The wiper may be mechanical, magnetic, electromechanical, electric, or any other form of a wiper to clear clogged tubes or align particles for entry into the pre-separation structure of the ESP. The wiper may also be a device used to back flush the ESP to clear clogged tubes.

The following may or may not be used in the device in whole or in part. Assisting the wiper inside both the HPZ and the GCA is an electrical excitation device (FIG. 1A). The electrical excitation device is used to prepare the molecules inside of the HPZ to be broken apart by the high pressure change and or separation process performed in the ESP (FIG. 5A). This electrical separation device is a frequency and voltage dependant preparatory device and may also aid in the filling of valence electrons to make the resultant elements/molecules more stable post ESP. A photo stimulator may also be used for the purposes defined above for the electrical excitation device.

The following may or may not be used in the device in whole or in part. There may be another electrical and/or light stimulation device after the ESP to facilitate the particles which were broken up inside of the ESP to stay apart. The electrical stimulation device uses voltage and frequency to fill the outer shells of the atoms or molecules. This facilitates in keeping the particles and atoms separated and not recombining. This stimulation may also be facilitated by using photo stimulation.

The following may or may not be used in the device. A small amount of fluid one may pass through the ESP and enter into the GCA. Any fluid one that is collected in this area will be recycled via a drainage system to the reservoir for future system use. The drainage of the fluid one will be facilitated by an evacuation system that is electromechanical, mechanical or other method(s).

The following may or may not be used in the device in whole or in part. The pressurization device (FIG. 1G) for the HPZ shall be located anywhere within or connected to the system. The pressurization device (PD) may be a single device or a series of devices to reach the desired pressure to overcome the fluid one bonds by means of pressure waves. The PD will be directly piped into the HPZ in a closed pressure chamber (FIG. 2C). The PD will supply pressure to the cylinders or movable section of a HPZ such as in figures FIGS. 2A and 2B.

The following may or may not be used in the device in whole or in part. In the case of FIG. 2A and FIG. 2B a tight tolerance will be required and 1 or more seals including but not limited to chevrons (shown in FIG. 4) to maintain a pressure seal and thus increase the pressure inside of the HPZ when the cylinders or slides are moved. In the systems FIGS. 2A and 2B the inlet into the HPZ is connected to the reservoir so that the HPZ is recharged with fluid one when the cylinders return stroke after reaching a maximum stroke length. This is facilitated with a check valve which will refill the HPZ once the cylinders begin to pressure the fluid one again. A sleeve material may be used between the ESP and the wall(s) of the HPZ which will increase the seal strength and longevity.

The combined volume occupied by the HPZ, ESP, and GCA shall be a minimum of 0.00000025 cm̂3 and as large as is needed for volume production. Any and all variations needed larger than this volume are included in this patent.

The following may or may not be used in the device in whole or in part. Between the ESP and the GCA and before or after the electrical stimulation device(s) a super collision device (FIG. 1P) is used to further break apart atoms, molecules, or compound substances by use of the high pressure difference existing between the HPZ and the GCA to accelerate molecules to a point where they collide with the super collision device. This super collision device (SCD) may be used in different configurations of the device depending on the change in pressure and the ESP.

The following may or may not be used in the device in whole, in part, or in combination. The method(s) of separation are at least one of the following: sudden high pressure differential which rips apart the working fluid (FIG. 6A); high pressure impact when the whole molecule is expelled from the structure of the ESP and then it collides with the super collision device (FIG. 6C); stripping a molecule into it's part(s) through varied, similar, or same sized structures in the ESP (FIG. 6B); or by means of a rotary device that strips bonds by means of a rotary device (FIG. 6F). It is possible in each of the Figures that the molecule will be separated into its elemental components entirely or partially. Any of these methods can be used in combination or separate from each other.

The following may or may not be used in the device in whole or in part. The following describes the Elemental Separation Plate (ESP) in FIG. 4. The ESP has support structure on either side of a cavity that is composed of one and possibly multiple of the following: a pre-separation structure, a separation structure and a post-separation structure, and possibly containing a support structure. The Pre-Separation and Post-Separation structure shapes can be any shape or combination of shapes including but not limited to the following: straight (FIG. 3E), diverging (FIG. 3F), and converging (FIG. 3G), or varied and randomized (permeable or semi-permeable) (FIG. 3H). The intermediary separation structure can be straight (FIG. 3A), biconvex (FIG. 3B), Plano-convex, Positive meniscus, negative meniscus, Plano-concave, biconcave (FIG. 3C), or varied and/or randomized (permeable or semi-permeable) (FIG. 3D). The pre-separation structure, intermediate separation structure, and post-separation structures can be offset or lined up in any configuration in each layer or between separation structures to aid in separation of the desired substance into its desired resultants. The ESP structure may incorporate various levels of continuous or separated work to break larger resultant molecules into even smaller desired end resultant particles/molecules. The ESP may also include heat exchanger(s), magnets, and changing separation structures built into the design.

The ESP may be supported by a support structure. It is not necessary that the support structure however be used as the entire HPZ may be constructed of solely the elements making up an ESP. The most common circumstance will be an ESP that is incorporated with a support structure.

The separation structures making up the ESP will be as close to the size of the desired shear filtering substance as possible. This can be achieved in many ways including but not limited to the following ways and shapes individually or separately: tube creation and filling or layering the tube to get to the final desired size (FIG. 3I), direct tube (FIG. 3J), offset or non uniformed filling or tube blockage (FIG. 3K), having a molecule or other object blocking part of the tube (FIG. 3L), deforming a tube to become a desired tube (FIG. 3M and FIG. 3N), using a varied or randomized pattern to shear off selected molecular portions or elements (FIG. 3O), off setting layers of the tubing in a structured and/or randomized way including one or as many subsequent tubes as is necessary (FIG. 3P). The wall thickness of each tube or separation structure may be as thin or as thick as needed for design purposes for the specific sized element/molecules desired as an output.

After the lighter or heavier gas/fluid has left the GCA each line will lead to a gas/fluid separation unit (GFSU) (FIGS. 5B and 5C). The separators will further separate/purify the resultants into the desired outputs through any means necessary including but not limited to mechanical, electrical, magnetic, or electromechanical. The resultants can then be expelled or drawn from the GFSU in a purified form through any number of different ports or can continue as a mixture of the separated elements/molecules. The GCA may contain one or as many outlets as is necessary for the desired pressure and conditions within the GCA as desired.

This system uses the shearing and/or breaking of molecular bonds using pressure waves, rotary movements and/or high velocity collisions to separate the molecule. In FIG. 6A, it is illustrated that a molecule can gain high velocity to break apart as they undergo a high pressure differential. In FIGS. 6B-6D it is shown that a molecule may experience pressure shear in different ways depending on the shape of the molecule, which will shear off a part of the molecule. In FIG. 6E, it is illustrated that individual molecules wide (or multiple molecules) wide in a tube can gain high velocity to break apart as it undergoes a high pressure differential and thus is accelerated to a point that the molecule(s) collides with a plate and breaks apart. In FIG. 6F, it is illustrated that a rotary motion can be used that contains tight enough tolerances to break apart the molecules into their desired components, whether they be elemental or molecular in nature.

A flashback arrestor may be used at any point in the design to minimize damage due to an accidental or intentional ignition. A pump or vacuum may be used at any point throughout the post ESP design to remove the resultant products and increase the pressure differential of the device. The pressure differential is essential to the design of the system.

The system must be monitored by as many of the following, but not limited to the following, as is deemed necessary or not for a given application. System monitoring will be done by use of electrical, mechanical, electromechanical, optical, photonic, magnetic, and any other monitoring aid. This system does not include a process for monitoring but only provides for the means to do so with any system available from any source while still adhering to patent law.

The system shall be insulated with any insulation to protect the integrity of the system from freezing and to create a desired temperature inside the process. The insulation may surround all or part of the system. The insulation may be constructed of single or multiple layers including the incorporation of layers of regenerative exothermic substances(s), designed to be used multiple times for protection of the system from freezing.

The system may be able to recycle some of the products that are produced and be used for further decompilation. The products may be used for a variety of purposes including but not limited to creation of hydrogen for use in an internal combustion engine, for use with a proton exchange membrane or other device. The resultants of said processes are often pure water which can then be reintroduced into the reservoir of the system for recycled use.

A vapor extraction port may be used to in connection with the HPZ to extract any vapor or gas that is found in the HPZ. The presence of vapor would likely diminish the ability of the system to reach the critical pressure to overcome the forces of attraction at the molecular level and cause shear of each fluid one molecule.

### BRIEF DESCRIPTION OF FIGURES

FIG. 1: Elemental Separation Process Overview

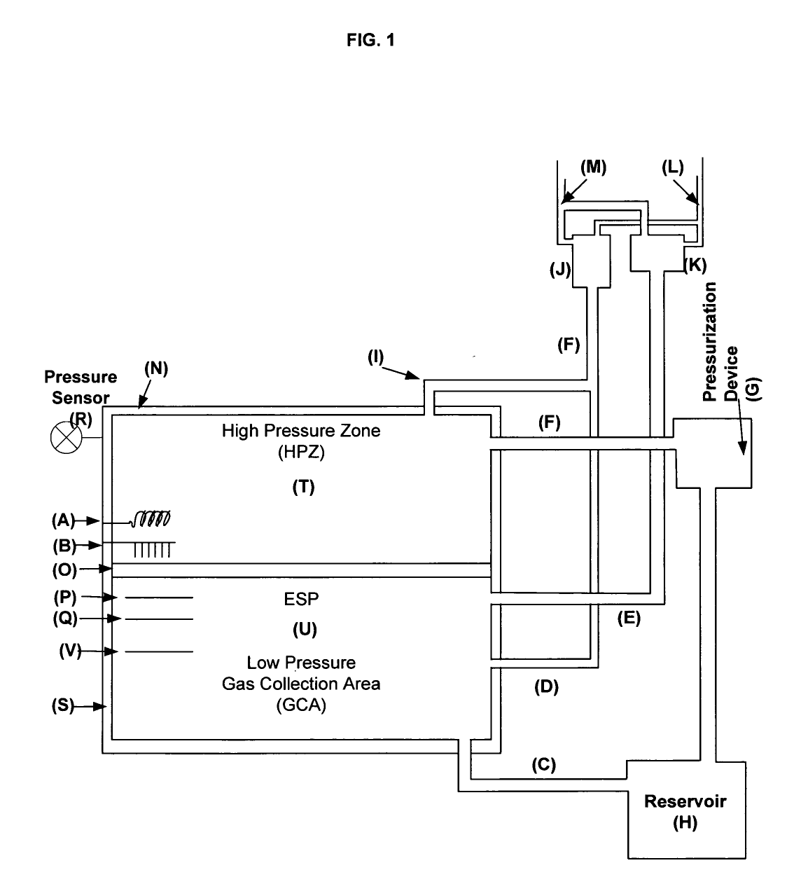

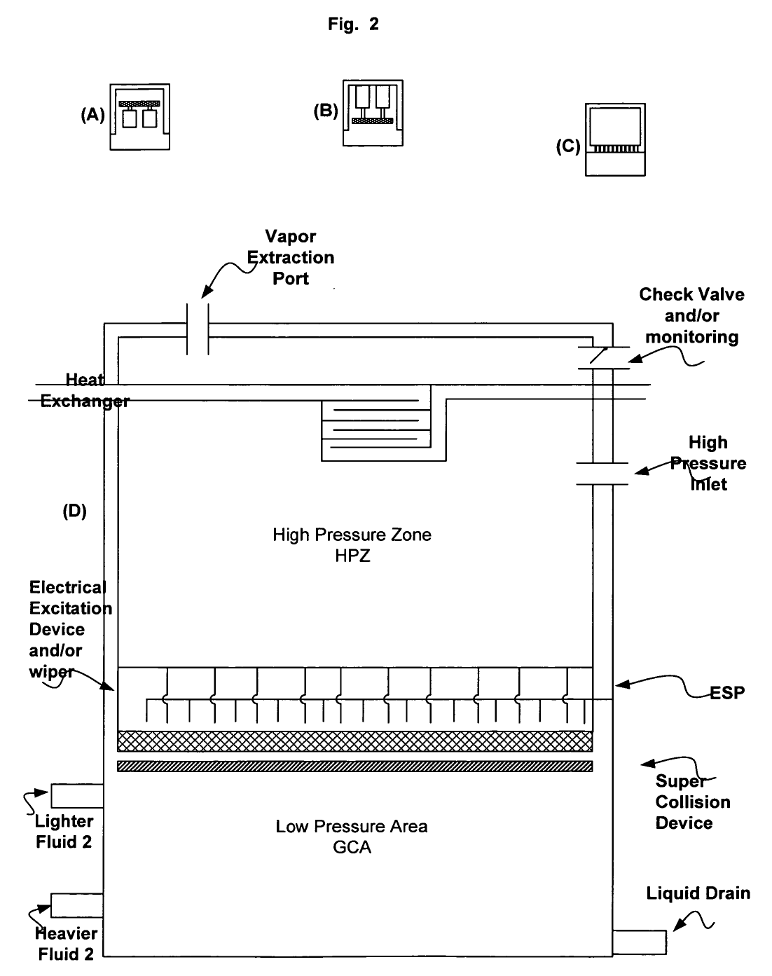

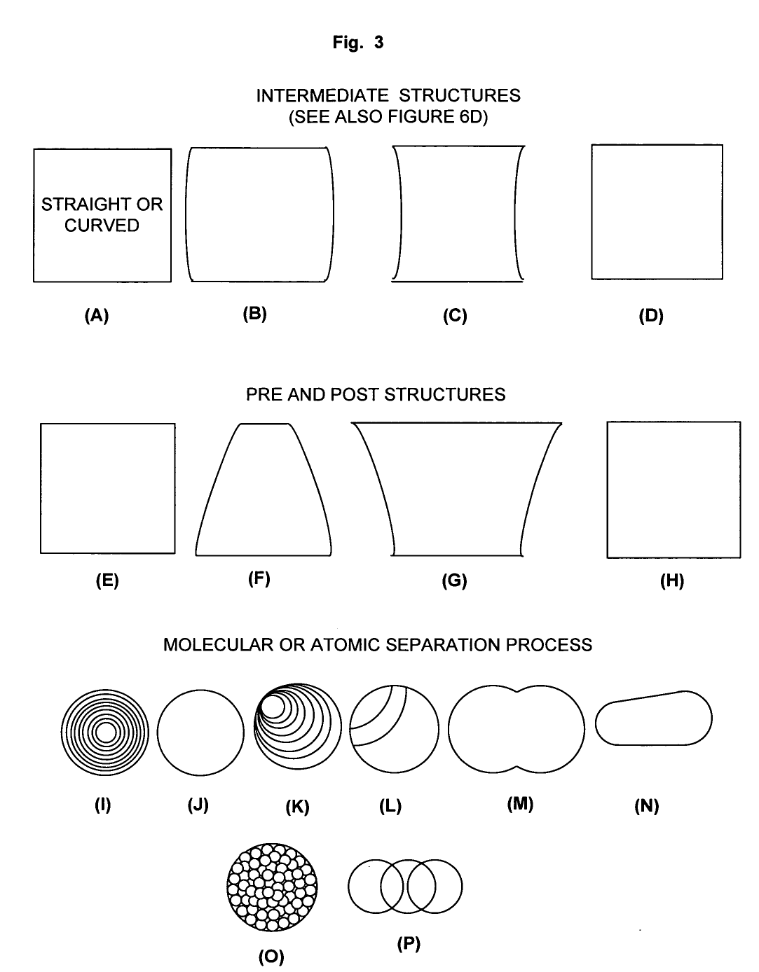

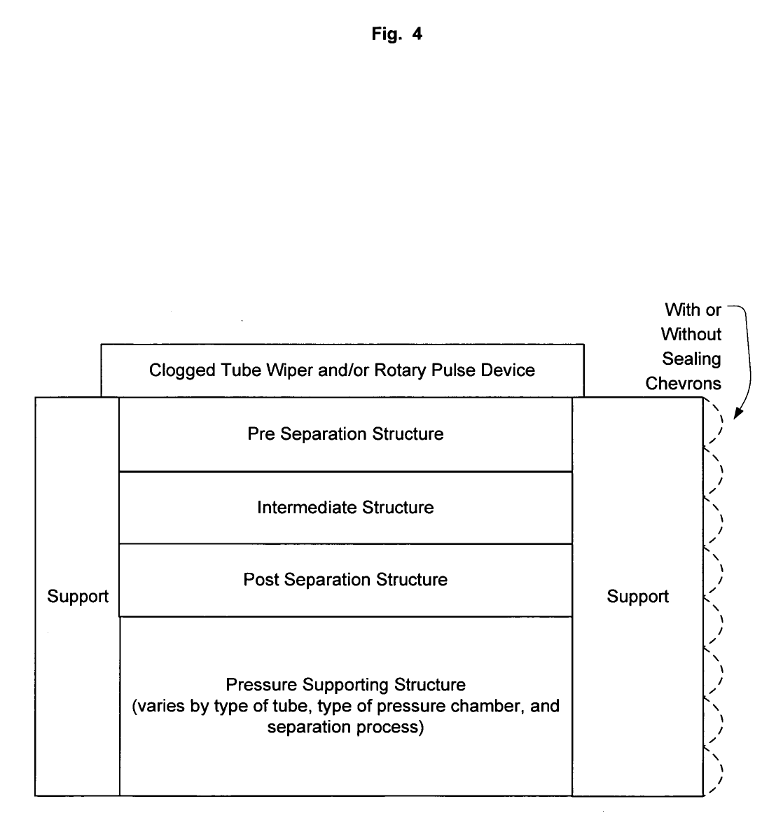

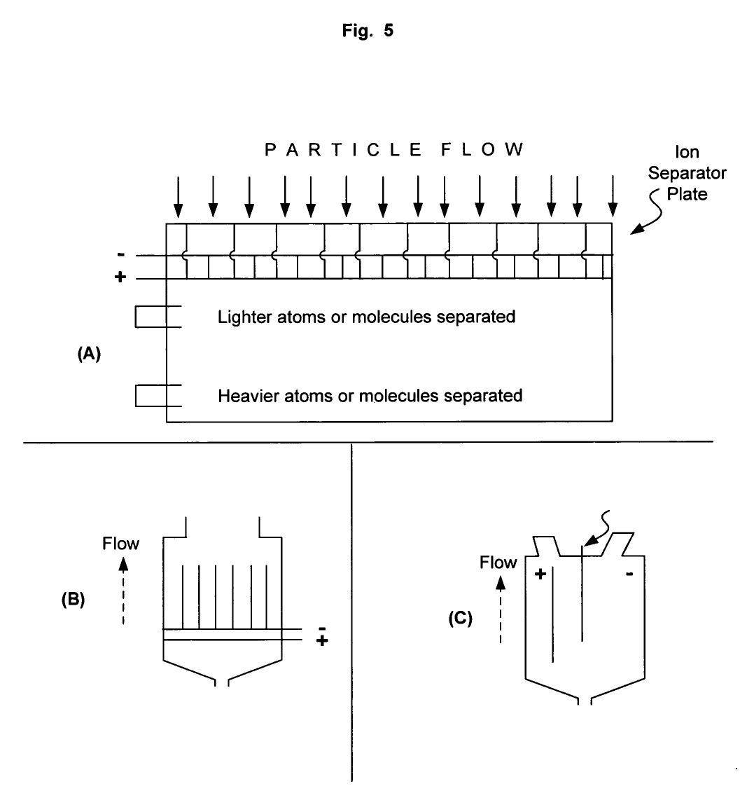

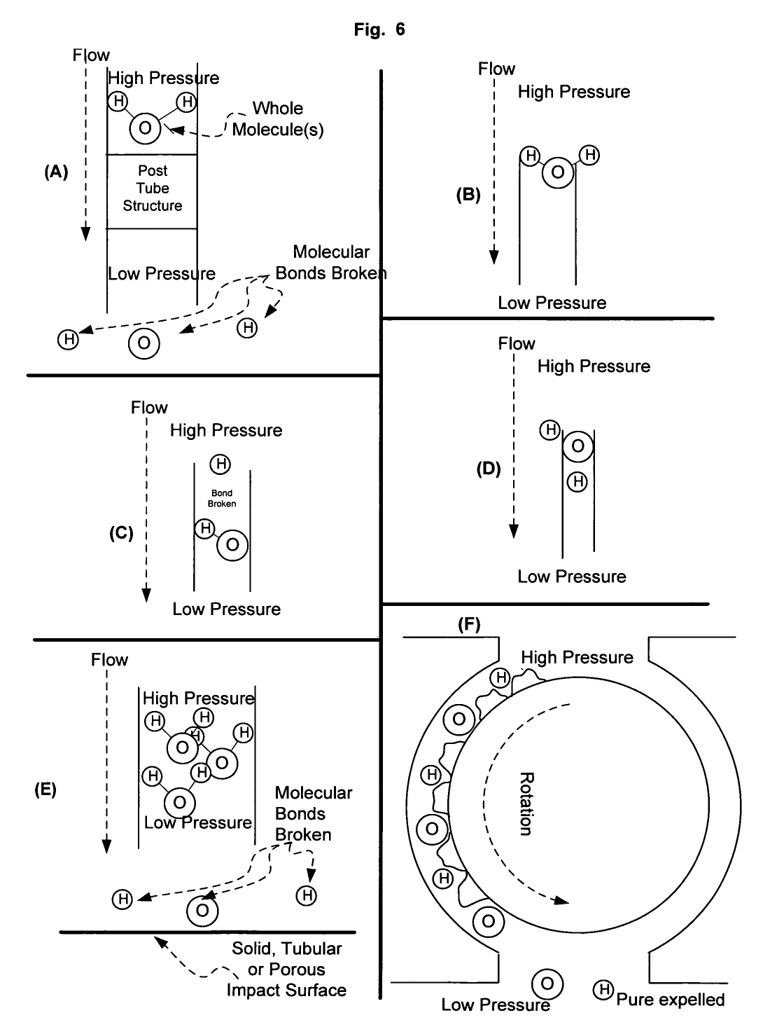

FIG. 2: Pressure Device Portion
A. Pressure Device, Cylinders Outside the Pressure Zone
B. Pressure Device, Cylinders Inside the Pressure Zone
C. Pressure Device, No Moveable Pressure Zone(s)
D. Elemental Separation Device Detail

FIG. 3: Pre, Post, Intermediate and Molecular Separation Methods
A. Straight intermediate separation structure shape
B. Biconvex varied and randomized intermediate separation structure shape
C. Plano-concave, varied and randomized biconcave intermediate separation structure shape
D. Varied and or randomized intermediate separation structure shape
E. Straight pre or post separation structure shape
F. Diverging pre or post separation structure shape
G. Converging pre or post separation structure shape
H. Varied and Randomized pre or post separation structure shape

FIG. 4: Elemental Separation Plate

FIG. 5: Elemental Separation Device Ion Separation Plate and Post Separation Details
A. Ion Separation Plate and Low Pressure Chamber
B. Gas Separation Unit
C. Gas Separation Unit

FIG. 6: Methods of Separation
A. ESP Structure Equal to Molecule Size
B. ESP Structure Variant 1 to Molecule Size
C. ESP Structure Variant 2 to Molecule Size
D. ESP Structure Variant 3 to Molecule Size
E. ESP Structure Variant 4 to Molecule Size
F. ESP Structure Rotational Separation Device

I claim:

1. An elemental Separation device is used to separate components of a molecule from the larger molecule or separate a molecule into smaller pieces. This system uses the shearing and/or breaking of molecular bonds using pressure waves, sudden pressure differentials resulting in explosive decompilation, rotary movements, high velocity collisions to separate the molecule, or any combination of these methods. The system uses high voltage to no voltage to facilitate the broken particles to remain in a separated state. For simplification purposes in the patent the terminology will fixate on the separation of hydrogen from water molecules rather than to refer to all combinations, however, this patent refers in general to the separation of compound molecular structures/molecules/atoms of any size, shape, or configuration into a baser unit, separation of molecular components, or for distillation purposes. The process combinations described below can be used in any industry and for any reason without limitation. The devices mentioned in this application can be made of any material which supports the strains, stresses and pressures under which they are exerted with the understanding that all materials are subject to possible wear and deformations. Materials used for the process may be homogeneous; however, in most applications a variety of materials and combinations of materials will be used for components. The materials may undergo material tempering or they may not. For this process all levels of tempering and material strengthening are assumed included herein.

2. The system in claim 1 uses a high pressure generation device to supply high pressure.

3. The system in claim 1 uses a high pressure zone in conjunction with an elemental separation plate and a gas collection area to breakdown molecules.

4. The system in claim 3 uses pressure differential(s) and shaping of the areas to break down the molecules.

5. The system in claim 1 uses port(s) leading out of the gas collection area to transfer the gas produced or fluid one passed through the ESP away from the Gas Collection Area described in claim 3.

6. The pressure generation device in claim 3 is supplied by a reservoir of the working fluid one which may be pure or not.

7. The system in claim 1 may use a wiper to clear debris from the Elemental separation plate.

8. The system in claim 1 may use a heat exchanger located in any portion of the device.

9. The system in claim 1 may use an electrical stimulation device to prepare orientation and/or prepare and/or aid in molecule separation within the high pressure zone of claim 3.

10. The system in claim 1 may use a photon stimulation device to prepare orientation and/or prepare and/or aid in molecule separation within the high pressure zone of claim 3.

11. The system in claim 1 may use an electrical stimulation device to prepare orientation and/or prepare and/or aid in molecule separation within the gas collection area of claim 3.

12. The system in claim 1 may use a photo stimulation device to prepare orientation and/or prepare and/or aid in molecule separation within the gas collection area of claim 3.

13. The system in claim 1 may or may not use a super collision device located in the gas collection area of claim 3 to aid in breaking apart molecules.

14. The elemental separation plate from claim 3 may be constructed by any number of layers, in any orientation to other layers and each layer may be in any geometry to aid in any combination of the methods in claim 1.

15. The fluid or gas expelled from the port(s) in claim 5 may be directed to a gas/fluid separation unit (GFSU). In each GFSU the fluid two will be separated or further purified into the produced forms of the fluid for use or reprocessing.

16. In conjunction with claim 1 a flashback arrestor may be used to isolate sections of the process. These may be placed at any point in the process.

17. All previous claims may be monitored by any means.

18. All systems in previous claims may be insulated for protection from freezing or to maintain a desired environment.

19. A control device (or devices) may be used in conjunction with the above claims to control pressure at any point.

20. The products of the system may be used in any number of systems and may therefore be reintroduced at any point in the system for any purpose(s).
